(19) United States
(12) Patent Application Publication
(10) Pub. No.: US 2002/0183905 A1
(43) Pub. Date: Dec. 5, 2002

(54) Drive recorder for motor vehicle and data reading apparatus for the same

(75) Inventors: Takashi Maeda, Tokyo (JP); Hiroshi Fujioka, Tokyo (JP); Takanori Matsunaga, Tokyo (JP); Toshinori Matsui, Tokyo (JP)

Correspondence Address: SUGHRUE, MION, ZINN, MACPEAK & SEAS, 2100 Pennsylvania Avenue, N.W., Washington, DC, 20037, US

(73) Assignee: MITSUBISHI DENKI KABUSHIKI KAISHA

(21) Appl. No.: 09/996,601

(22) Filed: Nov. 30, 2001

(30) Foreign Application Priority Data
Jun. 1, 2001 (JP) 2001-166388

(51) Int. Cl. G06F 19/00

(52) U.S. Cl. 701/35; 340/438

(57) ABSTRACT

A drive recorder for a motor vehicle capable of ensuring high security against a third party without need for using a password system. The drive recorder includes a volatile memory (102) for constantly recording various vehicle operation data concerning operation of a motor vehicle, a collision detecting means (120) for detecting a collision event of the motor vehicle, a transfer means for transferring the vehicle operation data stored in the volatile memory (102) before, upon or after occurrence of the collision event, and a nonvolatile memory (104) for recording and holding the vehicle operation data transferred thereto, wherein the transfer means includes an encryption means (103) which is designed for encrypting the vehicle operation data. The nonvolatile memory (104) is designed for recording and holding the encrypted vehicle operation data.

### BACKGROUND OF THE INVENTION

1. Field of the Invention

The present invention generally relates to a drive recorder for recording data concerning operation of an automobile or motor vehicle (hereinafter also referred to simply as the vehicle operation data) and analytically determining the cause of accident such as collision, if occurred, by reproducing the recorded data. More particularly, the present invention is concerned with a drive recorder for a motor vehicle which can ensure high security for such vehicle operation data.

2. Description of Related Art

The drive recorder for the motor vehicle (hereinafter also referred to simply as the drive recorder) designed for recording and holding various vehicle operation data inclusive of behaviors of the motor vehicle in precedence to and upon occurrence of collision is well known in the art.

By way of example, there is disclosed in Japanese Patent Application Laid-Open Publication No. 123876/1997(JP-A-9-123876) a drive recorder for a motor vehicle which includes a recording unit for recording vehicle operation data over a predetermined time span in the course of driving or running of a motor vehicle and a password system designed to enable data writing, reading and erasure in dependence on a first password code inherent to the owner (or driver) of the motor vehicle, a second password code managed solely by a relevant public institute or agency and an inputted password code.

In the conventional drive recorder for the motor vehicle disclosed in the publication mentioned above, the vehicle operation data are recorded by the recording unit in the course of running the motor vehicle. The recording operation is stopped when vehicle collision event occurs, and a copy of the record is held or managed as the record of accident.

For processing the recorded accident data after the collision event, the second password code mentioned above is inputted to the drive recorder, whereupon matching or collation of the second password code is performed by the password system incorporated in the drive recorder. Only when coincidence is detected between the password code inputted and the password code stored in the drive recorder, it is possible to read out and/or erase the vehicle operation data recorded and held.

By virtue of the arrangement described above, unauthorized access to the data recorded by the drive recorder is disenabled, and security is thus ensured for the recorded data.

In this conjunction, it should however be noted that in the case of the conventional drive recorder such as described above, no measures for ensuring the security of the recorded data themselves are taken. Accordingly, in order to ensure the security for the recorded vehicle operation data by inhibiting a third party from making access to the data, inputting of the second password code for the collation is prerequisite.

Furthermore, for ensuring the identity of the motor vehicle and the driver relevant to the recorded vehicle operation data while inhibiting forgery thereof by the third party, the password inputting/collating function is required. To this end, a password system designed for fetching the password code for collation thereof has to be incorporated in the drive recorder equipment.

As is apparent from the above, in the conventional drive recorder, it is indispensably required to provide for the drive recorder equipment the password system having the password code inputting function and the password code collating or matching function, which however incurs high expesiveness in implementation of the drive recorder equipment. Additionally, because of necessity of the password system to be incorporated in the drive recorder, it becomes impossible to ensure the security in case the recording unit is designed to be removable Besides, since the password system is built in the drive recorder, it is necessary to connect an appropriate analyzer to the drive recorder and input the password code to the drive recorder to read out the recorded vehicle operation data in order to analyze the behavior of the motor vehicle on the basis of the vehicle operation data recorded before occurrence of accident, which involves however troublesome handling.

As will now be understood from the foregoing, the conventional drive recorder for the motor vehicle suffers a problem that because no measures for ensuring the security of the recorded vehicle operation data themselves are adopted, it is required to provide the password system having the password code input function and the collating function in association with the drive recorder equipment, rendering the equipment very expensive.

Additionally, because of the necessity for the password system, there will arise a problem that the security can not be ensured, in the case where the recording unit is designed to be removable.

Besides, for analyzing the behavior of the motor vehicle on the basis of the vehicle operation data recorded before occurrence of accident, there are demanded not only the drive recorder but also the analyzer to be connected to the drive recorder, incurring thus inconveniency in handling.

### SUMMARY OF THE INVENTION

In the light of the state of the art described above, it is an object of the present invention to provide a drive recorder for a motor vehicle which can ensure the security against unauthorized access by a third party without need for providing the password system having password inputting and collating functions in association with the drive recorder.

Another object of the present invention is to provide a drive recorder for a motor vehicle which can ensure the security functions such as ensuring of the identity of a motor vehicle or driver relevant to the vehicle operation data recorded, capability of detecting the possibility of forgery of the vehicle operation data by a third party or outsider while evading the necessity for incorporating the password system in the drive recorder equipment.

A further object of the present invention is to provide a recorded vehicle operation data reading apparatus which can easily or conveniently be handled for analyzing the behavior of the motor vehicle on the basis of the recorded vehicle operation data by using the drive recorder which is so designed as to allow a nonvolatile memory for recording therein the vehicle operation data to be removably attached to the drive recorder equipment.

In view of the above and other objects which will become apparent as the description proceeds, there is provided according to a first aspect of the present invention a drive recorder for a motor vehicle, which recorder includes a volatile memory for constantly recording various vehicle operation data concerning operation of a motor vehicle, a collision detecting means for detecting a collision event of the motor vehicle, a transfer means for transferring the vehicle operation data stored in the volatile memory before, upon or after occurrence of the collision event, and a nonvolatile memory for recording and holding the vehicle operation data transferred thereto, wherein the transfer means mentioned above includes an encryption means which is designed for encrypting the vehicle operation data, and wherein the nonvolatile memory is designed for recording and holding the encrypted vehicle operation data.

According to a second aspect of the present invention, there is provided a drive recorder for a motor vehicle, which recorder includes a volatile memory for constantly recording various vehicle operation data concerning operation of a motor vehicle, a collision detecting means for detecting a collision event of the motor vehicle, a transfer means for transferring the vehicle operation data stored in the volatile memory before, upon or after occurrence of the collision event, and a nonvolatile memory for recording and holding the vehicle operation data transferred thereto, wherein the transfer mean mentioned above includes an encryption means which is designed for subscribing a digital signature to the vehicle operation data by resorting to a public key cryptography, and wherein the nonvolatile memory is designed for recording and holding the vehicle operation data affixed with the digital signature.

According to a third aspect of the present invention, there is provided a drive recorder for a motor vehicle, which includes a volatile memory for constantly recording various vehicle operation data concerning operation of a motor vehicle, a collision detecting means for detecting a collision event of the motor vehicle, a transfer means for transferring the vehicle operation data stored in the volatile memory before, upon or after occurrence of the collision event, and a nonvolatile memory for recording and holding the vehicle operation data transferred thereto, wherein the drive recorder further includes an encryption means which is designed for encrypting the vehicle operation data, and wherein the volatile memory is designed for recording constantly the encrypted vehicle operation data.

According to a fourth aspect of the present invention, there is provided a drive recorder for a motor vehicle, which includes a volatile memory for constantly recording various vehicle operation data concerning operation of a motor vehicle, a collision detecting means for detecting a collision event of the motor vehicle, a transfer means for transferring the vehicle operation data stored in the volatile memory before, upon or after occurrence of the collision event, and a nonvolatile memory for recording and holding the vehicle operation data transferred thereto, wherein the drive recorder further includes an encryption means which is designed for subscribing a digital signature to the vehicle operation data by resorting to a public key cryptography, and wherein the volatile memory is designed for recording constantly the vehicle operation data affixed with the digital signature.

In a preferred mode for carrying out the present invention, the drive recorder for a motor vehicle may further include a connecting means for removably connecting the nonvolatile memory to the drive recorder. In another preferred mode for carrying out the present invention, a data reading apparatus may be provided for reading out data from the drive recorder, which apparatus includes a connection port for receiving removably the nonvolatile memory carrying the vehicle operation data and removed from the above-mentioned connecting means, a reading means for reading the vehicle operation data recorded on the nonvolatile memory, a decryption means for decrypting the vehicle operation data read out from the nonvolatile memory, and a recording medium for recording thereon the decrypted vehicle operation data.

By virtue of the structure of the drive recorder for the motor vehicle according to the present invention described above, security of the recorded vehicle operation data against the unauthorized access by a third party can be ensured without need for providing the password system having the password code inputting and collating functions in association with the drive recorder.

Furthermore, owing to the features described above, there can be ensured the security functions such as ensuring of the identity of a motor vehicle or driver relevant to the vehicle operation data recorded, capability of detecting the possibility of forgery of the vehicle operation data by a third party or outsider while evading the necessity of incorporating the password system in the drive recorder for the motor vehicle.

Besides, the nonvolatile memory can easily be handled owing to the provision of the connecting means capable of removably connecting the nonvolatile memory.

Additionally, the recorded data reading apparatus can easily be handled in analyzing the behavior of the motor vehicle because the nonvolatile memory can removably be attached to the drive recorder equipment.

The above and other objects, features and attendant advantages of the present invention will more easily be understood by reading the following description of the preferred embodiments thereof taken, only by way of example, in conjunction with the accompanying drawings.

### BRIEF DESCRIPTION OF THE DRAWINGS

In the course of the description which follows, reference is made to the drawings, in which:

FIG. 1 is a block diagram showing schematically a general arrangement of a drive recorder for a motor vehicle according to a first embodiment of the present invention;

FIG. 2 is a flow chart for illustrating operation of the drive recorder for the motor vehicle according to the first embodiment of the present invention;

FIG. 3 is a block diagram showing schematically a general arrangement of a drive recorder for a motor vehicle according to a second embodiment of the present invention;

FIG. 4 is a flow chart for illustrating operation of the drive recorder for the motor vehicle according to the second embodiment of the present invention; and

FIG. 5 is a block diagram showing schematically a general arrangement of a data reading apparatus for reading data from the drive recorder according to a fourth embodiment of the present invention.

### DESCRIPTION OF THE PREFERRED EMBODIMENTS

The present invention will be described in detail in conjunction with what is presently considered as preferred or typical embodiments thereof by reference to the drawings. In the following description, like reference numerals designate like or corresponding parts throughout the several views.

Embodiment 1

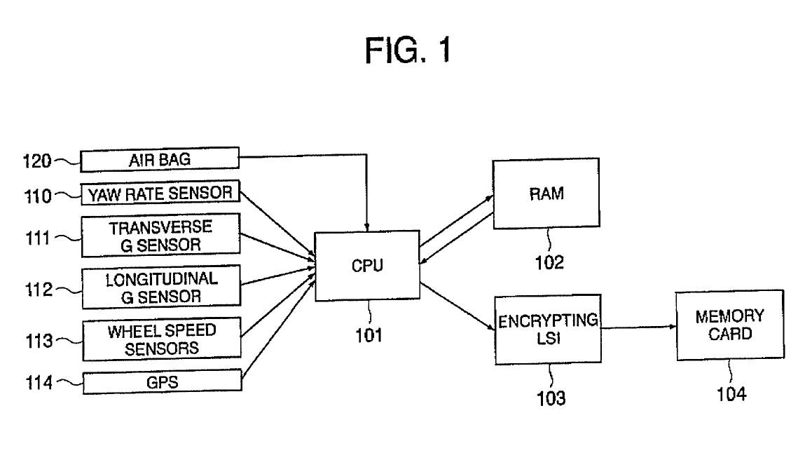

FIG. 1 is a block diagram showing schematically a general arrangement of a drive recorder for a motor vehicle according to the present invention.

Referring to FIG. 1, the drive recorder includes a CPU (Central Processing Unit) 101 designed or programmed for controlling overall operation of the drive recorder on the basis of the detection information derived from the outputs of various sensors described later on.

Connected to the CPU 101 are a RAM (Random Access Memory) 102 and an encrypting LSI (Large-Scale-Integrated Circuit) 103. A memory card 104 is connected to the encrypting LSI 103.

The RAM 102 serves as a volatile memory for recording constantly the detection information (detection values) derived from the outputs of the various sensors. The encrypting LSI 103 functions as an encryption means for encrypting input data thereto for thereby outputting encrypted data. The memory card 104 serves as a nonvolatile memory which can removably be attached or connected to the drive recorder equipment.

As the various sensors operatively connected to the CPU 101, there may be mentioned a yaw rate sensor 110, a transverse G (gravity) sensor 111, a longitudinal G (gravity) sensor 112, wheel-speed sensors 113, a GPS (Global Positioning System) 114, an air bag 120 and others, The wheel-speed sensors 113 are provided in association with the four wheels, respectively, of the motor vehicle. The air bag 120 serves as a collision detecting means for detecting occurrence of collision event by outputting an actuation signal upon actuation or operation.

The CPU 101 shown in FIG. 1 constitutes a data transfer means in cooperation with the encrypting LSI 103 for transferring to the memory card 104 the vehicle operation data stored in the RAM 102 before, upon or after occurrence of the collision event.

Thus, the memory card 104 is designed to record and hold the encrypted vehicle operation data.

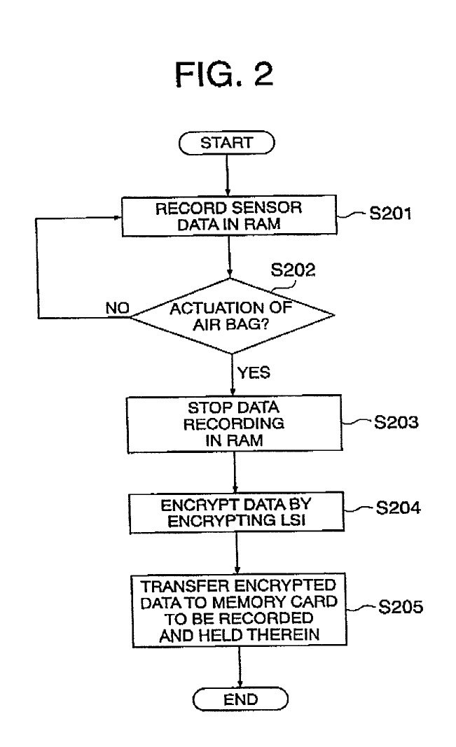

Next, referring to the flow chart shown in FIG. 2 together with FIG. 1, description will be made of operation of the drive recorder for the motor vehicle according to the first embodiment of the present invention.

When the motor vehicle equipped with the drive recorder starts to ran, the detection information outputted from the various sensors 110 to 114 is time-serially transferred to the RAM 102 through the medium of the CPU 101 to be recorded therein (step S201 in FIG. 2).

Subsequently, decision is made as to whether or not the air bag 120 is actuated (i.e., whether or not the actuation signal of the air bag 120 is inputted to the CPU 101) in a step S202. When it is decided that the air bag 120 is not actuated (i.e., when the decision step S202 results in negation “no”), the step S201 is resumed to continue the recording operation.

In other words, so long as the motor vehicle is running continuously in a normal state, the contents of the vehicle operation data stored in the RAM 102 are updated while holding the various sensor data fetched during every latest period of several ten seconds.

On the other hand, when the actuation signal of the air bag 120 is detected by the CPU 101 with the actuation of the air bag 120 being decided in the step S202 (i.e., when the decision step S202 results in affirmation “yes”), the CPU 101 stops the updating of the contents of the RAM 102 (step S203).

In succession, the CPU 101 transfers the data derived from the outputs of the various sensors and recorded in the RAM 102 to the encrypting LSI 103, whereby the vehicle operation data undergo encryption (step S204). In this conjunction, the data encryption may be performed by resorting to e.g. a public key cryptography.

Subsequently, the encrypted vehicle operation data are transferred to the memory card 104 from the encrypting LSI 103 to be recorded and held in the memory card 104 (step S205). At the time point when the data transferring/writing operation for the memory card 104 has been completed, the processing routine illustrated in FIG. 2 is terminated, whereby the operation of the drive recorder is stopped.

In this manner, the various sensor data of the motor vehicle (i.e., vehicle operation data concerning operation of the motor vehicle) are encrypted and recorded in the memory card 104 over a time period of several ten seconds before occurrence of accident. In this conjunction, it should be noted that since the vehicle operation data themselves are encrypted, it is impossible to read the recorded data from the memory card 104 detached from the drive recorder equipment unless an appropriate decryption means is employed.

Thus, the vehicle operation data can be protected against leakage to the third party, whereby the security of the recorded data can be ensured with high reliability.

Further, by executing the encryption processing on the vehicle operation data, inputting of a password code to the drive recorder for reading the data is rendered unnecessary. By virtue of this feature, security can be ensured without need for providing the password system having the input function and the collating function such as described hereinbefore in conjunction with the related art. Thus, the drive recorder according to the present invention can be implemented inexpensively.

Besides, because the connecting means designed for removably connecting the memory card 104 to the drive recorder or the motor vehicle and hence to the drive recorder is provided, handling of the memory card 104 can be facilitated.

Embodiment 2

In the case of the drive recorder for the motor vehicle according to the first embodiment of the present invention, the encrypting LSI 103 is interposed between the CPU 101 and the memory card 104. However, the encrypting LSI 103 may be interposed between the CPU 101 and the RAM 102.

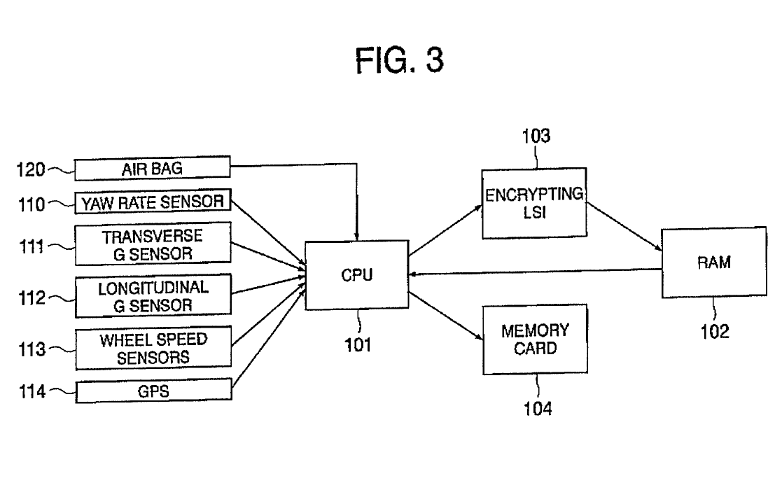

FIG. 3 is a block diagram showing schematically a general arrangement of the drive recorder for the motor vehicle according to a second embodiment of the present invention in which the encrypting LSI 103 is provided between the CPU 101 and the RAM 102. In FIG. 3, like or equivalent components as those described previously by reference to FIG. 1 are denoted by like reference numerals, and repeated description thereof will be omitted.

As can be seen from comparison of FIG. 3 with FIG. 1, the drive recorder according to the second embodiment of the invention differs from the first embodiment only in the respects that the encrypting LSI 103 is disposed between the CPU 101 and the RAM 102 and that the memory card 104 is directly connected to the CPU 101.

The encrypting LSI 103 encrypts the vehicle operation data inputted thereto via the CPU 101. The encrypted vehicle operation data are then outputted to the RAM 102. The RAM 102 thus records constantly the encrypted vehicle operation data.

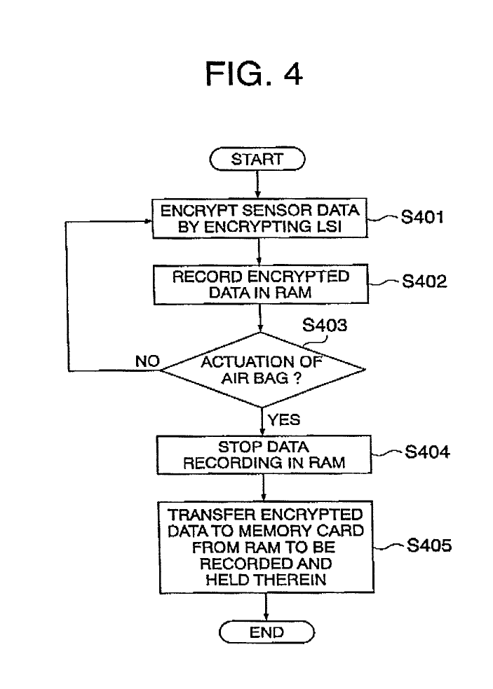

Next, referring to the flow chart shown in FIG. 4 together with FIG. 3, description will be made of the drive recorder according to the second embodiment of the invention.

In FIG. 4, the steps S401, S402 and S403 correspond to the steps S204, S202 and S203, respectively.

When the motor vehicle equipped with the drive recorder starts to run, the detection information outputted from the various sensors 110 to 114 is time-serially transferred to the encrypting LSI 103 through the medium of the CPU 101 to be encrypted (step S401 in FIG. 4), as in the case of the first embodiment described previously (see step S204 in FIG. 2).

The RAM 102 stores or records therein time-serially the vehicle operation data encrypted by the encrypting LSI 103 (step S402). In the step S403, decision is made as to actuation of the air bag 120. When this decision step S403 results in “no”, indicating that the air bag 120 is not actuated, the step S403 is resumed to continue the recording operation.

On the other hand, when the decision step S403 results in “yes”, indicating actuation of the air bag 120, the CPU 101 stops updating of the RAM 102 (step S404), whereupon the encrypted vehicle operation data recorded in the RAM 102 are transferred to the memory card 104 (step S405).

At the time point when the data writing operation for the memory card 104 has been completed, the processing routine shown in FIG. 4 comes to an end with the operation of the drive recorder being stopped.

In this case, the vehicle operation data fetched over the time period of several ten seconds preceding to the occurrence of accidence are recorded in the memory card 104 in the encrypted form. Since the vehicle operation data themselves are encrypted, it is impossible to read out explicitly the vehicle operation data from the memory card 104 detached from the drive recorder unless the appropriate decryption means is available.

Thus, the vehicle operation data can be protected against leakage to the third party, whereby the security of the recorded data can be ensured with high reliability. Besides, because the password system is not required, the drive recorder equipment can be realized inexpensively.

Embodiment 3

In the case of the drive recorders according to the first and second embodiments described above, encryption of the vehicle operation data is performed in the step S202 (FIG. 2) or step 5402 (FIG. 4) by resorting to the public key cryptography. In this conjunction, a digital signature may be subscribed to the vehicle operation data by making use of the public key cryptography.

In that case, such procedure may be adopted that the vehicle operation data is first encrypted by using a private (or secrete) key inherent to the motor vehicle or driver and the encrypted vehicle operation data is again encrypted by using a public key published by a relevant public institute or agency established for analytically studying the cause of accident by referencing the recorded vehicle operation data after occurrence of the accident. In other words, encryption of the vehicle operation data may duplicately be performed.

More specifically, in the encrypting LSI 103 shown in FIG. 1, the digital signature is subscribed to the vehicle operation data by resorting to the public key cryptography, whereon the vehicle operation data affixed with the digital signature is recorded in the memory card 104 to be held therein.

Alternatively, the digital signature may be subscribed to the vehicle operation data by resorting to the public key cryptography in the encrypting LSI 103 shown in FIG. 3, so that the vehicle operation data affixed with the digital signature can constantly be recorded in the RAM 102 to be held therein.

By affixing the digital signature as described above, the vehicle operation data undergo complicated encryption, whereby the leakage to the third party can be prevented with higher security. Besides, the motor vehicle and/or the driver relevant to the recorded vehicle operation data can be specified. Moreover, it becomes possible to detect any forgery made by a third party.

AS is apparent from the above, according to the teachings of the present invention incarnated in the third embodiment thereof, the motor vehicle and/or the driver relevant to the vehicle operation data can discriminatively be identified. Besides, forgery of the vehicle operation data by the third party can easily be detected. Thus, the security of the vehicle operation data can be enhanced significantly. Besides, by subscribing the digital signature to the vehicle operation data, inputting of the password code to the drive recorder described hereinbefore in conjunction with the related art is rendered unnecessary. By virtue of this feature, security can be ensured without need for providing the password system. Thus, the drive recorder equipment according to the invention can be implemented inexpensively.

Embodiment 4

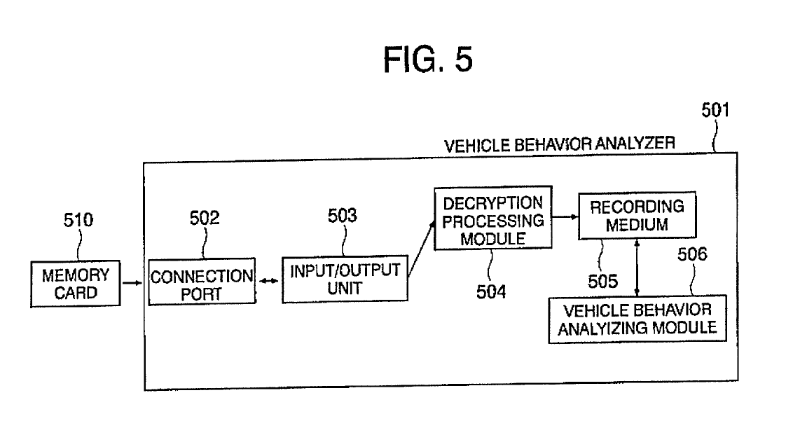

A fourth embodiment of the present invention is directed to a data reading apparatus for reading out the data from the memory card (nonvolatile memory) FIG. 5 is a block diagram showing schematically a general arrangement of the data reading apparatus for reading the data from the memory card detached from the drive recorder for the motor vehicle. It is presumed that the data reading apparatus incorporates a vehicle behavior analyzing function.

Referring to FIG. 5, a memory card 510 is shown in the state removed or detached from the drive recorder equipment described hereinbefore (FIGS. 1 and 3) and connected to a vehicle behavior analyzer 501 which constitutes the data reading apparatus.

The vehicle behavior analyzer 501 is comprised of a connection port 502 through which the memory card 510 detached from the connecting means mentioned previously is removably inserted, an I/O (input/output) unit 503 for performing vehicle operation data transaction with the memory card 510, a decryption processing module 504 for decrypting the encrypted vehicle operation data, a recording medium 505 for recording the vehicle operation data for making it possible to reference the data, and a vehicle behavior analyzing module 506 for analyzing the behavior of the motor vehicle on the basis of the vehicle operation data.

Next, description will be made of the operation of the data reading apparatus for the drive recorder equipment according to the instant embodiment of the invention shown in FIG. 5.

At first, when the memory card 510 is inserted into the connection port 502, the vehicle behavior analyzer 501 fetches the encrypted vehicle data from the memory card 510 through the medium of the I/O unit 503 which constitutes a data reading means.

Subsequently, a decryption processing module 504 incorporated in the vehicle behavior analyzer 501 decrypts or decode the vehicle operation data as fetched.

In that case, decryption even for the vehicle operation data encrypted by using the public key in the drive recorder as described hereinbefore can be realized by using a private or secrete key corresponding to the public key, Subsequently, the decrypted vehicle operation data are recorded on the recording medium 505 for saving, Thereafter, the vehicle behavior analyzing module 506 of the vehicle behavior analyzer 501 may analyze the vehicle behavior at the time when accident occurred.

With the arrangement of the data reading apparatus described above, the decrypted vehicle operation data are recorded on the recording medium 505 simply by connecting or inserting the memory card 510 into the connection port 502 of the vehicle behavior analyzer 501. Thus, the behavior analysis of the of the motor vehicle can be carried out on the basis of the vehicle operation data recorded on the recording medium 505 without involving any troublesome handling.

Furthermore, since the data reading operation can be performed simply by connecting the memory card 510 carrying the vehicle operation data undergone the encryption processing to the vehicle behavior analyzer (data reading apparatus) 501, the data reading apparatus for the drive recorder can easily be handled in the step of executing the behavior analysis of the motor vehicle on the basis of the vehicle operation data.

Additionally, since the vehicle operation data themselves recorded on the memory card 104 have undergone the encryption processing, the data reading from the memory card 104 is rendered impossible without using the appropriate decryption means (decryption processing module 504). Thus, even though the memory card 510 is implemented to be removably attached to the main body of the drive recorder, high security can be ensured.

Many modifications and variations of the present invention are possible in the light of the above techniques. It is therefore to be understood that within the scope of the appended claims, the invention may be practiced otherwise than as specifically described.

What is claimed is:

1. A drive recorder for a motor vehicle, comprising:
a volatile memory for constantly recording various vehicle operation data concerning operation of a motor vehicle;
collision detecting means for detecting a collision event of said motor vehicle;
transfer means for transferring the vehicle operation data stored in said volatile memory before, upon or after occurrence of said collision event; and
a nonvolatile memory for recording and holding said vehicle operation data transferred thereto,
wherein said transfer means includes encryption means designed for encrypting said vehicle operation data, and
wherein said nonvolatile memory is designed for recording and holding the encrypted vehicle operation data.

2. A drive recorder for a motor vehicle according to claim 1,
further comprising:
connecting means for removably connecting said nonvolatile memory to said drive recorder.

3. A data reading apparatus for the drive recorder set forth in claim 2, comprising:
a connection port for receiving removably said nonvolatile memory carrying the vehicle operation data and removed from said connecting means;
reading means for reading the vehicle operation data recorded on said nonvolatile memory;
decryption means for decrypting said vehicle operation data read out from said nonvolatile memory; and
a recording medium for recording thereon said decrypted vehicle operation data.

4. A drive recorder for a motor vehicle according to claim 1, wherein
said encryption means is designed for subscribing a digital signature to said vehicle operation data by resorting to a public key cryptography, and
said nonvolatile memory is designed for recording and holding said vehicle operation data affixed with the digital signature.

5. A drive recorder for a motor vehicle, comprising:
a volatile memory for constantly recording various vehicle operation data concerning operation of a motor vehicle;
collision detecting means for detecting a collision event of said motor vehicle;
transfer means for transferring the vehicle operation data stored in said volatile memory before, upon or after occurrence of said collision event; and
a nonvolatile memory for recording and holding said vehicle operation data transferred thereto,
said drive recorder further comprising:
encryption means,
wherein said encryption means is designed for encrypting said vehicle operation data, and
wherein said volatile memory is designed for recording constantly the encrypted vehicle operation data.

6. A drive recorder for a motor vehicle according to claim 5,
further comprising:
connecting means for removably connecting said nonvolatile memory to said drive recorder.

7. A data reading apparatus for the drive recorder set forth in claim 6, comprising:
a connection port for receiving removably said nonvolatile memory carrying the vehicle operation data and removed from said connecting means;
reading means for reading the vehicle operation data recorded on said nonvolatile memory;
decryption means for decrypting said vehicle operation data read out from said nonvolatile memory; and
a recording medium for recording thereon said decrypted vehicle operation data.

8. A drive recorder for a motor vehicle according to claim 5, wherein
said encryption means is designed for subscribing a digital signature to said vehicle operation data by resorting to a public key cryptography, and
wherein said volatile memory is designed for recording constantly said vehicle operation data affixed with the digital signature.
